(19) United States
(12) Patent Application Publication
(10) Pub. No.: US 2008/0096139 A1
(43) Pub. Date: Apr. 24, 2008

(54) Mastering Based On Heat-Induced Shrinkage Of Organic Dyes

(75) Inventors: Erwin Rinaldo Meinders, Eindhoven (NL); Joost Muller, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/722,884

(22) PCT Filed: Dec. 22, 2005
(86) PCT No.: PCT/IB05/54378

§ 371 Date: Jun. 27, 2007

(30) Foreign Application Priority Data
Jan. 6, 2005 (EP) 05100051.1

(51) Int. Cl. G11B 7/26; B41M 5/36

(52) U.S. Cl. 430/322

(57) ABSTRACT

The present invention relates to a method for providing a high-density relief structure in a recording stack of a master substrate, particularly a master substrate for making a stamper for the mass-fabrication of optical discs or a master substrate for making a stamp for micro contact printing. Furthermore, the present invention relates to a master substrate for creating a high-density relief structure, particularly a master substrate for making a stamper for the mass-fabrication of optical discs or a master substrate for making a stamp for micro contact printing. The invention also relates to a special use of a master substrate that comprises a dye layer, as well as to a master substrate comprising a high-density relief structure. Furthermore, the present invention relates to a stamper for the mass-fabrication of optical discs, an optical disc, and a microprint. In accordance with all aspects of the present invention a high-density relief structure required for all of the above applications is directly or indirectly formed by laser pulse induced shrinkage of dye layer material.

### FIELD OF THE INVENTION

The present invention relates to a method for providing a high-density relief structure in a recording stack of a master substrate, particularly a master substrate for making a stamper for the mass-fabrication of optical discs or a master substrate for creating a stamp for micro contact printing. Furthermore, the present invention relates to a master substrate for creating a high-density relief structure, particularly a master substrate for making a stamper for the mass-fabrication of optical discs or a master substrate for making a stamp for micro contact printing. The invention also relates to a special use of a master substrate that comprises a dye layer, as well as to a master substrate comprising a high-density relief structure. Furthermore, the present invention relates to methods for making stampers for the mass-fabrication of optical discs, optical discs, stamps for micro contact printing, and microprints.

### BACKGROUND OF THE INVENTION

Relief structures that are manufactured on the basis of optical processes can, for example, be used as a stamper for the mass replication of read-only memory (ROM) and pre-grooved write-once (R) and rewriteable (RE) discs. The manufacturing of such a stamper, as used in a replication process, is known as mastering.

In conventional mastering, a thin photosensitive layer, spincoated on a glass substrate, is illuminated with a modulated focused laser beam. The modulation of the laser beam causes that some parts of the master substrate are being exposed by UV light while the intermediate areas in between the pits to be formed remain unexposed. While the disc rotates, and the focused laser beam is gradually pulled to the outer side of the disc, a spiral of alternating illuminated areas remains. In a second step, the exposed areas are being dissolved in a so-called development process to end up with physical holes inside the photo-resist layer. Alkaline liquids such as NaOH and KOH are used to dissolve the exposed areas. The structured surface of the master substrate is subsequently covered with a thin Ni layer. In a galvanic process, this sputter-deposited Ni layer is further grown to a thick manageable Ni substrate comprising the inverse pit structure. This Ni substrate with protruding bumps is separated from the master substrate and is called the stamper.

Phase-transition mastering (PTM) is a relatively new method to make high-density ROM and RE/iR stampers for mass-fabrication of optical discs. Phase-transition materials can be transformed from the initial unwritten state to a different state via laser-induced heating. Heating of the recording stack can, for example, cause mixing, melting, amorphisation, phase-separation, decomposition, etc. One of the two phases, the initial or the written state, dissolves faster in acids or alkaline development liquids than the other phase does. In this way, a written data pattern can be transformed to a high-density relief structure with protruding bumps or pits. Also in this case the patterned substrate can be used as a stamper for the mass-fabrication of high-density optical discs or as a stamp for micro-contact printing.

In this connection it was already proposed to use fast-growth phase-change materials and recording stacks for phase-transition mastering. The growth-dominated phase-change materials possess a high contrast in dissolution rate of the amorphous and crystalline phase. The amorphous marks, obtained by melt-quenching of the crystalline material, can be dissolved in concentrated conventional alkaline developer liquids, such as KOH and NaOH but also in acids like HCl, HNO₃ and H₂SO₄. Re-crystallization in the tail of the mark can be used to reduce the mark length in a controlled manner. In particular in case of the smallest mark, the I2, the re-crystallization in the tail of the mark can lead to a crescent mark, with a length shorter than the optical spot size. In this way, the tangential data density can be increased.

A challenge of such a material system might be the relatively large number of recording stack layers needed to optimize the thermal and optical behavior of the recording stack. Another difficulty is the ability to make deep pit structures with such a material system.

It is therefore an object of the present invention to provide the possibility to create high-density relief structures on the basis of a relative simple recording stack.

### SUMMARY OF THE INVENTION

This object is solved by the features of the independent claims. Further developments and preferred embodiments of the invention are outlined in the dependent claims.

In accordance with a first aspect of the present invention, there is provided a method for providing a high-density relief structure in a recording stack of a master substrate, particularly a master substrate for making a stamper for the mass-fabrication of optical discs or a master substrate for making a stamp for micro contact printing, the method comprising the following steps:

providing a recording stack comprising a dye layer; and

shrinking dye layer material by applying laser pulses to create the high-density relief structure in the dye layer.

For example, Oxonol dyes possess the interesting property of shrinkage upon laser-induced heating. Due to the heating, carbonization of the organic dye material occurs which is accompanied by the formation of reaction products and a reduction of the exposed volume. This is, among other recording mechanisms, an important contribution to the conventional formation of a mark in a recordable disc based on such dyes. With the known recording techniques, shrinkage leads to a reduced optical path length, enabling the readout of written data. In contrary thereto, the present invention proposes to use this volumetric change for making a high-density relief structure with organic dye materials that possess such a shrinkage mechanism. Without being limited thereto, Blu-ray disc mastering is a possible application of the present invention. In this case recording is preferably done with 405 nm, but other wavelengths are also possible. All dye materials with sufficient absorption at this wavelength can be used for this application. The high-density relief structures created in accordance with the invention can not only be used to make stampers, used for the mass-replication of optical discs, but also for other two-dimensional structures like channel structures for biosensors and displays.

With preferred embodiments of the present invention, the dye of the dye layer is selected from the following group: oxonol-based dyes, phthalocyanine, cyanines, AZO. The thickness of the dye layer is, for example, between 40 and 100 nm, preferably between 60 and 80 nm.

In accordance with a further development of the present invention, the recording stack further comprises at least one reflection layer arranged below the dye layer.

The reflection layer is preferably made of a material selected from the following group: Ni, Ag, Al, SiO₂, Si₃N₄. The material used for the reflection layer in any case should have a different index of reflection than the dye of the dye layer. The thickness of the reflection layer may, for example, be between 5 and 40 nm thick, preferably, between 10 and 20 nm. The reflection layer underneath the dye layer may also act as an absorption layer to improve the temperature distribution in the dye layer.

At least with some embodiments of the present invention the recording stack further comprises at least one absorption layer arranged above and/or below the dye layer.

The absorption layer is preferably made of a material selected from the following group: Ni, Cu, GeSbTe, SnGeSb, InGeSbTe. The absorption layer is preferably etchable and relatively thin, for example, between 5 and 40 nm, preferably between 5 and 10 nm.

In accordance with a second aspect of the present invention, there is provided a master substrate for creating a high-density relief structure, particularly a master substrate for making a stamper for the mass-fabrication of optical discs or a master substrate for making a stamp for micro contact printing, wherein the master substrate comprises a dye layer in which the high-density relief structure is to be formed by applying laser pulses that shrink dye layer material. Such a master substrate is suitable to be used with the method described above. Therefore, as regards the detailed characteristics and possible further developments, reference is made to the above description of the method in accordance with the first aspect of the present invention, to avoid repetitions.

The same applies to a third aspect of the present invention, directed to the use of a master substrate that comprises a dye layer to create a high-density relief structure in the dye layer by shrinking dye layer material by applying laser pulses.

In accordance with a fourth aspect of the present invention, there is provided a master substrate comprising a high-density relief structure that is formed in a dye layer by shrinkage of dye layer material. Such a master substrate may be obtained by carrying out the method in accordance with the first aspect of the present invention, and therefore, as regards details, reference is again made to the corresponding description.

In accordance with a fifth aspect of the present invention, there is provided a stamper for the mass-fabrication of optical discs, wherein the stamper is characterized in that it is made by the following process:

providing a recording stack comprising a dye layer;

shrinking dye layer material by applying laser pulses to create a high-density relief structure in the dye layer; and

making the stamper on the basis of the high-density relief structure by providing a metal layer on the dye layer.

To provide the metal layer, for example, a thin Ni layer is sputter-deposited on the high-density relief structure formed in the recording stack of the master substrate. This Ni layer is subsequently electro-chemically grown to a thick manageable stamper. The stamper is separated from the master substrate and further processed (cleaned, punched etc.) for being used for mass-replication of optical discs.

In accordance with a sixth aspect of the present invention, there is provided an optical disc, which is characterized in that it is made by following process:

providing a recording stack comprising a dye layer;

shrinking dye layer material by applying laser pulses to create the high-density relief structure in the dye layer;

making a stamper on the basis of the high-density relief structure; and

using the stamper to make the optical disc.

Also in this case, the high-density relief structure can be formed in accordance with the method of the present invention, and, in this connection, reference is again made to the corresponding description. The stamper used for making the optical can be of the type described above. The making of the optical disc itself is well known to the person skilled in the art and is therefore not described herein.

In accordance with a seventh aspect of the present invention, there is provided a microprint, which is characterized in that it is made by the following process:

providing a recording stack comprising a dye layer;

shrinking dye layer material by applying laser pulses to create the high-density relief structure in the dye layer;

making a stamp on the basis of the high-density relief structure;

using the stamp to make the microprint.

Again, the high-density relief structure can be formed in accordance with the method of the present invention. The making of the stamp on the basis of the high-density relief structure is well know to the person skilled in the art and can be carried out similar to the making of the stamper described above. The micro-printing process itself is also well known to the person skilled in the art and is therefore not described herein.

These and other aspects of the invention will be apparent from and elucidated with reference to the embodiments described hereinafter.

### BRIEF DESCRIPTION OF THE DRAWINGS

FIGS. 1a to 1c schematically illustrate a first embodiment of the method in accordance with the present invention, carried out on the basis of an embodiment of a master substrate in accordance with the present invention;

FIGS. 2a to 2f schematically illustrate the use of a master substrate in accordance with the invention to produce a stamper, an optical disc, and a microprint, respectively, all in accordance with the present invention;

FIG. 3 shows a surface analysis of the result of a practical experiment made on the basis of a conventional DVD+R L1 stack;

FIG. 4 shows a sectional analysis of the result of the practical experiment shown in FIG. 3; and

FIGS. 5 to 9 illustrate the results of Differential Scanning Calorimeter (DSC) and Thermal Gravimetric Analysis (TGA) measurements, performed on the basis of conventional DVD+R dyes.

### DESCRIPTION OF PREFERRED EMBODIMENTS

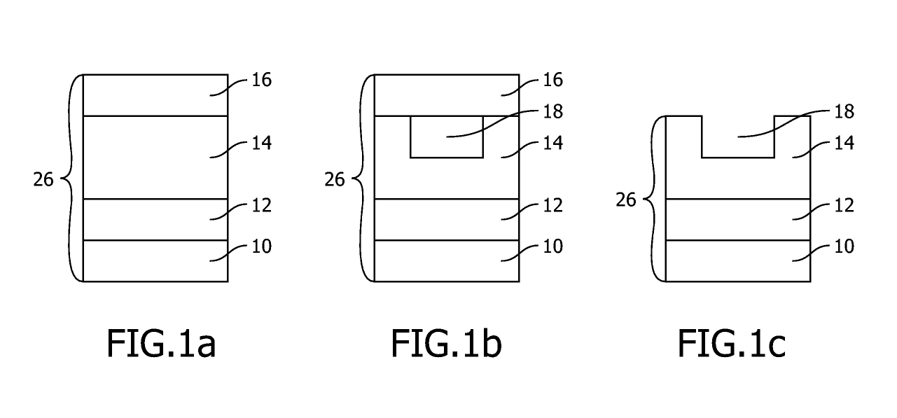

FIGS. 1a to 1c schematically illustrate a first embodiment of a method for providing a high-density relief structure 18 in a recording stack 12, 14, 16 of a master substrate 26 for making a stamper for the mass-fabrication of optical discs.

FIG. 1a shows the master substrate 26 in its initial state. The recording stack 12, 14, 16 is carried by a glass substrate 10 and comprises, in order of appearance seen from the direction of the incident laser beam, an absorption layer 16, an organic dye layer 14, and a reflection layer 16. The absorption layer 16 is etchable and is relatively thin, for example, between 5 and 40 nm, preferably between 5 and 10 nm. The dye layer 14 is preferably of the type oxonol dye. The dye layer thickness is between 40 and 100 nm, preferably between 60 and 80 nm. The reflection layer 12 may be Ni, for example, between 5 and 40 nm thick, preferably, between 10 and 20 nm. Also Ag and Al are suitable materials. Other dielectric layers such as SiO2 and Si3N4 may be used as reflector as long as the index of reflection does not match that of the dye.

FIG. 1b shows the master substrate 26 after the application of one or more laser pulses in a region where a pit 18 is to be formed. The pit 18 is formed by a heat-induced shrinkage of dye layer material.

FIG. 1c shows the master substrate 26 after an etching process was carried out to remove the absorption layer 16 to expose the pit 18. Suitable etching liquids are, for example, acids such as HNO3 and HCl.

It is clear for the person skilled in the art that the method in accordance with the invention is not limited to the creation of pits, but is suitable to create any high-density relief structure, depending on the demands.

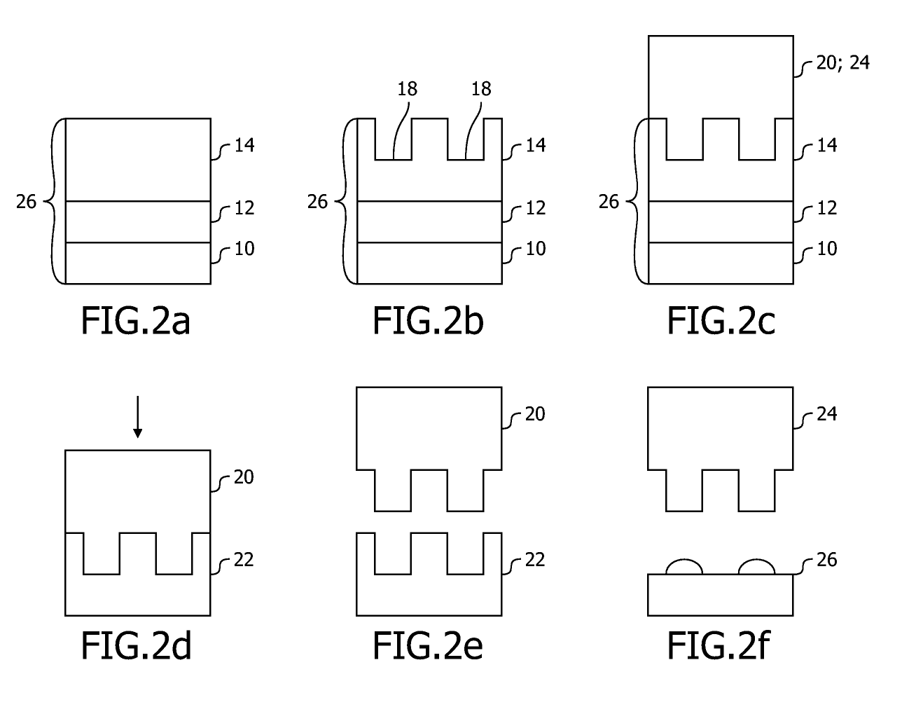

FIGS. 2a to 2f schematically illustrate the use of a master substrate 26 in accordance with the invention to produce a stamper 20 for making optical discs 22 (only one of which is partially shown) or a stamp 24 for making microprints 26 (only one of which is partially shown).

FIG. 2a shows the master substrate 26 in its initial state. The recording stack 12, 14 is carried by a glass substrate 10. In this case the recording stack comprises, in order of appearance seen from the direction of the incident laser beam, an organic dye layer 14 and a reflection layer 16. The layers may be equal or similar to those of FIG. 1a.

FIG. 2b shows the master substrate 26 after the application of one or more laser pulses in a region where a high-density relief structure 18 is to be formed. Although FIGS. 2a to 2c are used to illustrate both the formation of a stamper 20 and a stamp 24, it is clear for the person skilled in the art that the properties of the high-density relief structure 18 depend on the application. In any case the high-density relief structure 18 is formed by a heat-induced shrinkage of dye layer material.

In accordance with FIG. 2c a metal stamper 20 and a metal stamp 24, respectively, is formed on the basis of the high-density relief structure 18. To provide the metal layer, for example, a thin Ni layer is sputter-deposited on the high-density relief structure 18 formed in the recording stack 12, 14 of the master substrate 26. This Ni layer is subsequently electro-chemically grown to a thick manageable stamper 20 or stamp 24. The stamper 20 or the stamp 24 is separated from the master substrate 26 and further processed (cleaned, punched etc.).

FIGS. 2d and 2e schematically illustrate the production of an optical disc 22 on the basis of the Ni stamper 20 as it is well known to the person skilled in the art.

FIG. 2f schematically illustrates the making of a microprint 26 on the basis of the stamp 24.

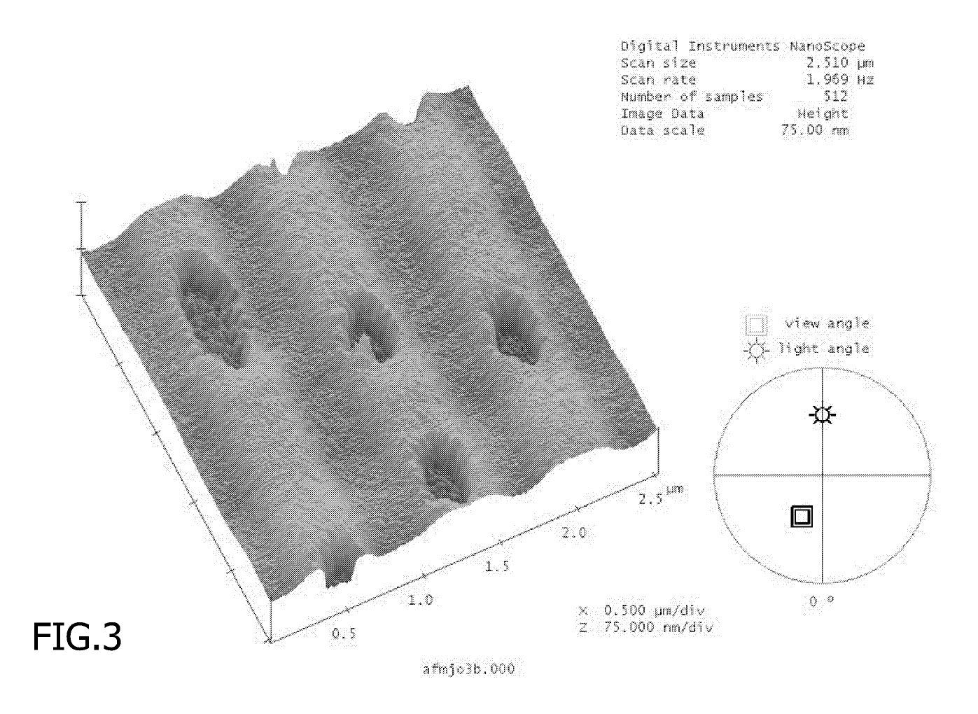

An example of a pit structure written in the L1 stack of a DVD+R dual-layer disc is given in the Atomic Force Microscopy (AFM) picture in FIG. 3. The disc was recorded at 658 nm wavelength (NA=0.65). The recording stack, comprising a thin Si₃N₄ absorption layer, a 100 nm thick dye layer and a 100 nm Ag reflection layer, was deposited on top of a pre-groove substrate. After recording, the disc was separated into two halves at the L1 dye layer. The disc was separated at the dye-Si₃N₄ interface. Laser-induced heating of the exposed areas leads to partial carbonization of the organic lattice and therefore, to a reduced volume. The created pits have very steep walls and are relatively deep. This pit shape is determined by the absorption profile in the dye layer. The absorption profile is fine tuned by the dye layer thickness, the optional metallic underlayer (reflector) and an optional top absorption layer.

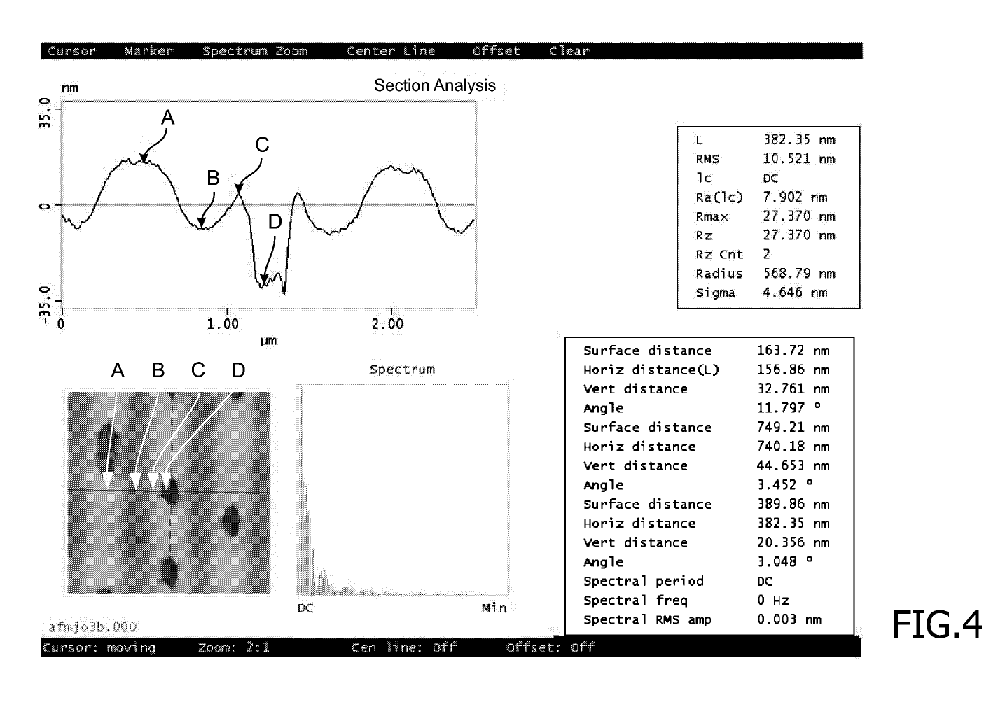

FIG. 4 shows a sectional analysis of the result of the practical experiment shown in FIG. 3. The pit shown in detail in FIG. 4 and written between to adjacent pre-grooves comprises very steep walls, as mentioned above.

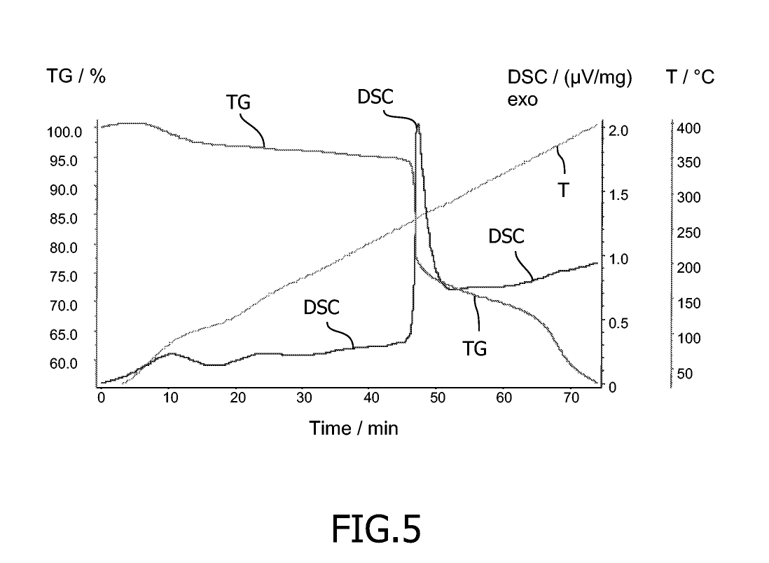

FIGS. 5 to 9 illustrate the results of Differential Scanning Calorimeter (DSC) and Thermal Gravimetric Analysis (TGA) measurements, performed on the basis of conventional DVD+R dyes. The transition temperatures are around 250-300° C., which is very beneficial for mastering. The relative mass reduction ranges from 30 to 90%.

FIG. 5 illustrates DSC and TGA analysis of a DVD+R dye (Organica 1140®). The sharp reduction in mass occurs at about 270° C. The relative volume change is 25%.

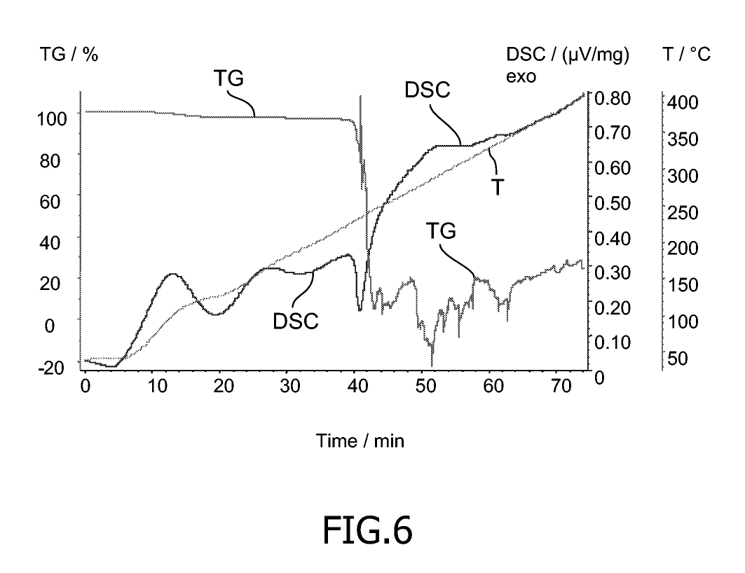

FIG. 6 illustrates DSC and TGA analysis of a DVD+R dye (Fuji®). In this case, the sharp reduction in mass occurs at about 250° C. The relative volume change is more than 90%.

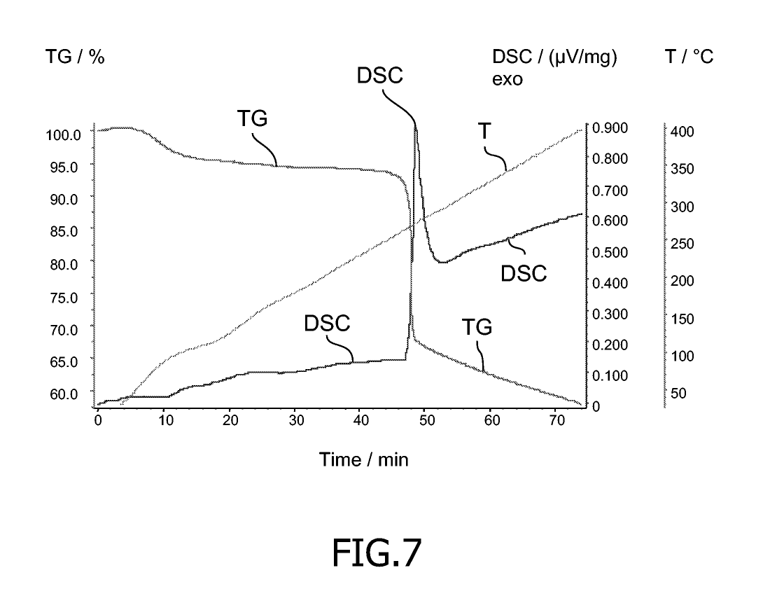

FIG. 7 illustrates DSC and TGA analysis of a DVD+R dye (Bayer®). Here, the sharp reduction in mass occurs at about 290° C. The relative volume change is more than 30%.

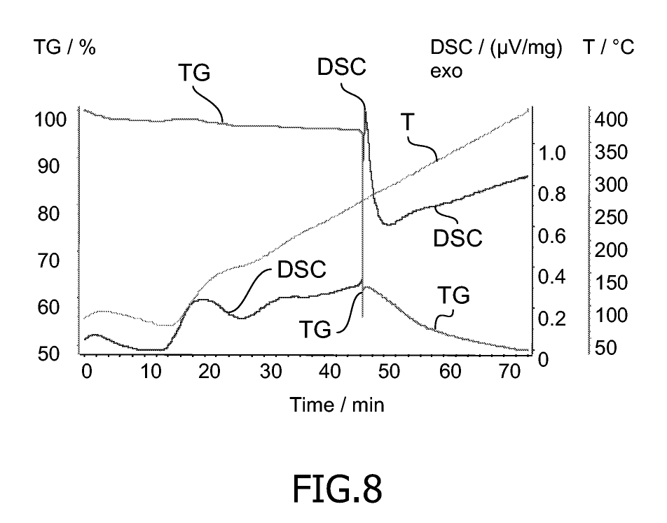

FIG. 8 illustrates DSC and TGA analysis of a DVD+R dye (MCCpds2211®). With this dye the sharp reduction in mass occurs at about 290° C. The relative volume change is about 40%.

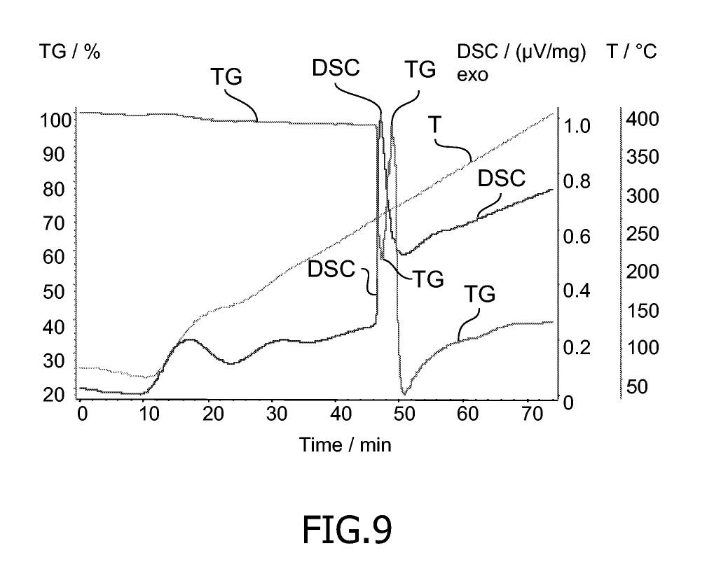

Finally, FIG. 9 illustrates DSC and TGA analysis of a DVD+R dye (MCC16X®). The sharp reduction in mass occurs at about 290° C. The relative volume change is about 60%.

It is to be noted that equivalents and modifications not described above may also be employed without departing from the scope of the invention, which is defined in the accompanying claims.

1. A method for providing a high-density relief structure (18) in a recording stack (12, 14, 16) of a master substrate (26), particularly a master substrate (26) for making a stamper (20) for the mass-fabrication of optical discs (22) or a master substrate (26) for making a stamp (24) for micro contact printing, the method comprising the following steps:
providing a recording stack (12, 14, 16) comprising a dye layer (14); and
shrinking dye layer material by applying laser pulses to create the high-density relief structure (18) in the dye layer (14).

2. The method according to claim 1, wherein the dye of the dye layer (14) is selected from the following group: oxonol-based dyes, phthalocyanine, cyanines, AZO.

3. The method according to claim 1, wherein the recording stack (12, 14, 16) further comprises at least one reflection layer (12) arranged below the dye layer (14).

4. The method according to claim 3, wherein the reflection layer (12) is made of a material selected from the following group: Ni, Ag, Al, SiO₂, Si₃N₄.

5. The method according to claim 1, wherein the recording stack (12, 14, 16) further comprises at least one absorption layer (16) arranged above and/or below the dye layer (14).

6. The method according to claim 5, wherein the absorption layer (16) is made of a material selected from the following group: Ni, Cu, GeSbTe, SnGeSb, InGeSbTe.

7. A master substrate (26) for creating a high-density relief structure (18), particularly a master substrate (26) for making a stamper (20) for the mass-fabrication of optical discs (22) or a master substrate (26) for making a stamp (24) for micro contact printing, wherein the master substrate (26) comprises a dye layer (14) in which the high-density relief structure (18) is to be formed by applying laser pulses that shrink dye layer material.

8. Use of a master substrate (26) that comprises a dye layer (14) to create a high-density relief structure (18) in the dye layer (14) by shrinking dye layer material by applying laser pulses.

9. A master substrate (26) comprising a high-density relief structure (18) that is formed in a dye layer (14) by shrinkage of dye layer material.

10. A method for making a stamper (20) for the mass-fabrication of optical discs (22), the method comprising the following steps:
providing a recording stack (12, 14, 16) comprising a dye layer (14);
shrinking dye layer material by applying laser pulses to create a high-density relief structure (18) in the dye layer (14); and
making the stamper (20) on the basis of the high-density relief structure (18) by providing a metal layer (20) on the dye layer (14).

11. A method for making an optical disc (22), the method comprising the following steps:
providing a recording stack (12, 14, 16) comprising a dye layer (14);
shrinking dye layer material by applying laser pulses to create the high-density relief structure (18) in the dye layer (14);
making a stamper (20) on the basis of the high-density relief structure (18); and
using the stamper (20) to make the optical disc (22).

12. A method for making a stamp (24) for micro contact printing, the method comprising the following steps:
providing a recording stack (12, 14, 16) comprising a dye layer (14);
shrinking dye layer material by applying laser pulses to create a high-density relief structure (18) in the dye layer (14); and
making the stamp (24) on the basis of the high-density relief structure (18) by providing a metal layer (20) on the dye layer (14).

13. A method for making a microprint (26), the method comprising the following steps:
providing a recording stack (12, 14, 16) comprising a dye layer (14);
shrinking dye layer material by applying laser pulses to create the high-density relief structure (18) in the dye layer (14);
making a stamp (24) on the basis of the high-density relief structure (18);
using the stamp (24) to make the microprint (26).
